(19) United States
(12) Patent Application Publication
(10) Pub. No.: US 2024/0198564 A1
(43) Pub. Date: Jun. 20, 2024

(54) TYPE OF ELASTIC HEEL AND ITS MANUFACTURING PROCESS, FOOTWEAR

(71) Applicant: Quanzhou Longte Weier Electronic Commerce Co., Ltd., Quanzhou (CN)

(72) Inventor: WEILING CHEN, Quanzhou (CN)

(21) Appl. No.: 18/367,341

(22) Filed: Sep. 12, 2023

(30) Foreign Application Priority Data
Dec. 16, 2022 (CN) 202211624574.7

(51) Int. Cl. B29C 44/58; A43D 86/00; B29C 44/02

(52) U.S. Cl. CPC B29C 44/58; A43D 86/00; B29C 44/02; B29K 2075/00

(57) ABSTRACT

The present invention relates to the field of shoe material technology, more particularly to a type of elastic heel and its manufacturing process, including the following steps: (1) material configuration: selecting a material from foam rubber, elastic PU, foamed latex, foam sponge, PVC foam and EVA foam required for configuration upon the need; (2) mold preparation: preparing the heel mold consisting of upper and lower platens, among which the inside surface of the lower platen is a concave while the inside surface of the upper platen is a convex, each having the same shape as the heel inner and outer surface, and there are venting holes on the upper platen, and on the inside surface of the lower platen lays elastic fabric; (3) placing the solid foaming material of the Step (1) in the mold and closing the mold halves to proceed foam forming; (4) opening the mold for demolding.

### CROSS-REFERENCE TO RELATED APPLICATIONS

This is a U.S. patent application which claims the priority and benefit of Chinese Patent Application Number 202211624574.7, filed on Dec. 16, 2022, the disclosure of which is incorporated herein by reference in its entirety.

### TECHNICAL FIELD

The present invention relates to the field of shoe material technology, more particularly to a type of elastic heel and its manufacturing process, including the following steps:

### BACKGROUND

The top line setting of current shoes generally includes the following types: 1. The top line is expanded or tightened through tying elements such as shoelaces, Velcro, etc. after setting a U-opening top line covered by the tongue; 2. The upper is seamless with elastic fabric for the top line, such as a fly-woven upper, meeting the need for top line expansion at shoes putting-on and taking-off and tightening at putting-on; 3. The top line is opened wider to meet the need at putting-on and taking-off. Such design is common in leather shoes that are easy to suffer heel slip after shoes are put on. Shoes on the prior art, in particular the casual shoes or sport shoes, need to pull up the heel by hand, which is not friendly to the people with bending difficulties such as the elderly and pregnant women; and people's demand for quick shoes wearing is increasing gradually as the pace of life accelerates.

Under this background, quick slip-on shoes have been being developed. The prior art disclosed a type of quick slip-on shoes with compressible lattices. The construction of compressible lattices allows the quick slip-on shoes to offset from the opening position towards the closing position. The opening position allows an expanded opening to facilitate the individual to slide the feet into the quick slip-on shoes quickly while the closing position allows a small opening to keep the feet well in the quick slip-on shoes. However, shoes with this type of construction have fairly complex units and lay high requirements on materials and processing cost, not good for popularization.

### SUMMARY

As the first aspect of the present invention, a type of elastic heel manufacturing process raised by the present invention is industrialized by the following means:

The manufacturing process of a type of elastic heel includes the steps as follows:
(1) Material configuration: selecting a material from foam rubber, elastic PU, foamed latex, foam sponge, PVC foam and EVA foam required for configuration upon the need;
(2) Mold preparation: preparing the heel mold consisting of upper and lower platens, among which the inside surface of the lower platen is a concave having the same shape as the heel outer surface while the inside surface of the upper platen is a convex having the same shape as the heel inner surface, and on the inside surface of the lower platen lays the elastic fabric;
(3) Placing the solid foaming material of Step (1) in the mold and close the mold halves to proceed foam forming;
(4) Opening the mold for demolding.

The improvements are that the lower platen consists of a cavity, a groove around the cavity, and slots for locking the mold halves, and that the upper platen consists of a core, a rib around the core, and clips at four corners to be fit into the slots of the lower platen. The said upper platen is designed with several venting holes.

The improvement is that the heel consists of an entrance portion, a transition portion, a container portion and a bottom portion from top to bottom. The said entrance portion has a curved rim inclining from the inner surface to the outer surface. The said transition portion, connected with the entrance portion, is an arc inclining from the outer surface to the inner surface and its slope inside is larger than that outside, forming a pressed platform extending inwards at the inner surface of the said entrance portion. The container portion is an arc bending towards the inner surface of the heel. The outer surface of the elastic heel is covered with curved lines set transversely along the heel. The two sides of the elastic heel also include connecting portions that are strips extending from the entrance portion of the heel to the bottom of the shoe.

Further, at the Step (2), the liquid ether-based two-component PU foam is filled in the lower platen first, and then the elastic fabric is placed in the upper platen followed by foaming molding after mold halves are closed, in case that the raw material at the Step (1) is a liquid ether-based two-component PU foam.

Further, the said ether-based two-component PU foam system consists of primary and secondary components; the said primary component is polyol mixture including the said secondary component, isocyanate pre-polymer, in proportion of 100/40-50 of the said primary component to secondary component.

Further, at the Step (1), the said isocyanate pre-polymer is conditioned in an oven at 60˜70° C. for 6˜10 hours until getting molten and then moved to another oven at 35-45° C. for thermal preservation; meanwhile the polyol is conditioned in an oven at 44˜55° C. for 6˜10 hours and then moved to another oven at 35˜45° C. for thermal preservation; and then the polyol is mixed with hardener 18-20 g/kg, catalyst 20-25 g/kg, foaming agent 9-13 g/kg, anti-yellowing agent 20-25 g/kg, and foam stabilizer 10-20 g/kg under 35-45° C. for 5˜15 minutes to get the primary component.

Further, the primary component is mixed with the secondary component in proportion of 100-40/60; its emulsification time is 6-10 s, cross-linking time 25-35 s, hands-off time 50-70 s, foaming time 80-90 s, and free foaming density 0.125-0.165 g/cm3.

Further, at said the Step (3) the mold pressing temperature is 40-55° C., and demolding time is 3-6 minutes.

Further, after demolding, the heel is conditioned in the oven at 60-70° C. for 8-12 hours.

Further, the obtained heel is trimmed to make the finished goods.

In comparison with the existing technologies, the benefits of the present invention are:
1. The heel making process of the present invention is one-piece molding. The process is simple, and it is good for introduction and application.
2. A heel made through the process of the present invention can be matched with various uppers to make various shoes. Its application is wide.
3. A heel made through the process of the present invention has convex in the transition portion of the heel inner surface, preventing shoes from falling out after they are put on to assure the stability while wearing.

### BRIEF DESCRIPTION OF DRAWINGS

FIG. 1 is the schematic view of the heel of the embodiment of the present invention;

FIG. 2 is the cross-sectional side view of the heel of the embodiment of the present invention;

FIG. 3 is the back-side schematic view of the heel of the embodiment of the present invention;

FIG. 4 is the top view of the schematic view of the heel of the embodiment of the present invention;

FIG. 5 is the bottom view of the embodiment of the schematic view of the heel of the present invention;

FIG. 6 is the overall schematic view of the heel of the embodiment of the present invention;

FIG. 7 is the cross-sectional side view of the heel of the embodiment 2 of the present invention;

FIG. 8 is the overall schematic view of the quick slip-on shoe of the embodiment of the present invention;

FIG. 9 is the schematic view of the closed mold of the embodiment of the present invention;

FIG. 10 is the schematic view of the upper platen of the mold of the embodiment of the present invention;

FIG. 11 is the schematic view of the lower platen of the mold of the embodiment of the present invention;

FIG. 12 is the schematic view of the insole of the embodiment of the present invention;

FIG. 13 is the schematic view of the insole of the embodiment of the present invention;

Inner surface 1, outer surface 2, entrance portion 3, pressed platform 30, transition portion 4, container portion 5, bottom portion 6, connecting portion 7, elastic fabric 8, webbing 9, insole body 10, filling area 11, sole filling area 110, toe filling area 111, heel filling area 112, upper platen 12, clip 121, rib 122, cavity 123, lower platen 13, slot 131, groove 132, core 133.

### DETAILED DESCRIPTION

To make the above purposes, characteristics and advantages of the present invention more evident and easier to understand, detailed description on the specific embodiments of the present invention as follows is made together with drawings.

The following description elaborates many specific details to make the present invention fully understood, but the present invention also can be embodied in other forms different from the description herein. Persons skilled in the art may make similar extensions without deviating from the spirit thereof. The present invention therefore is not limited to the forms of specific embodiments published below.

To make the purpose, technical solutions and advantages of the present invention more clear, further detailed description on the embodiment forms of the present invention is made as follows together with drawings.

### Embodiment 1

A type of elastic heel of this embodiment is designed into certain structure, and applied to sport shoes, casual shoes, etc. with the addition of material elasticity to make a type of quick slip-on shoes.

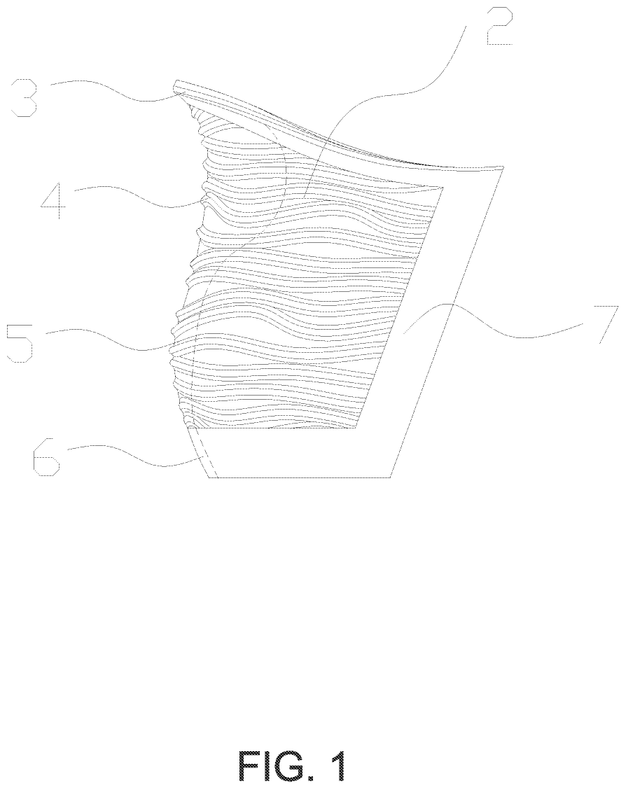

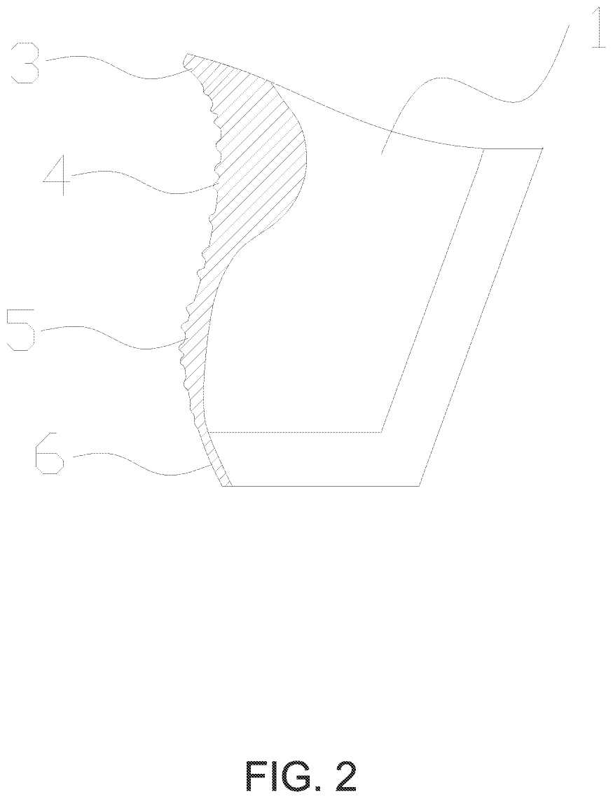

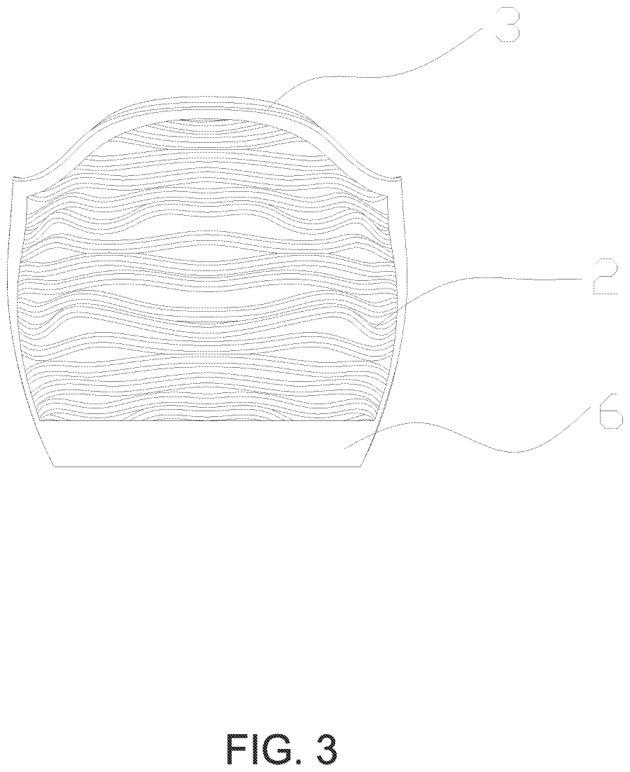

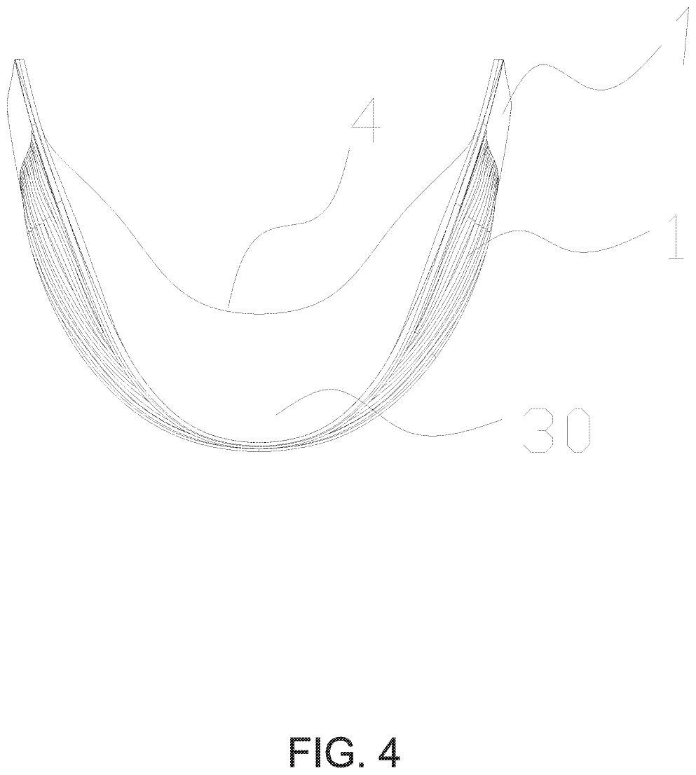

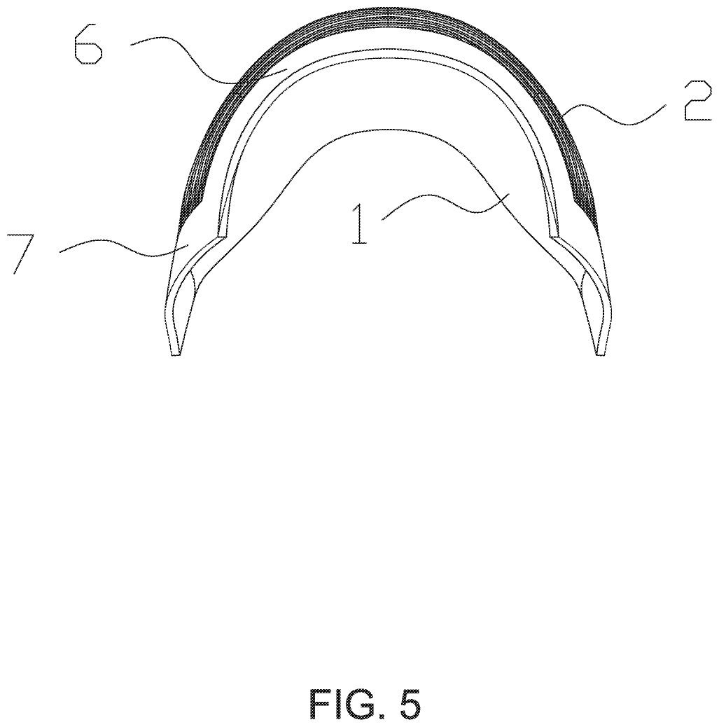

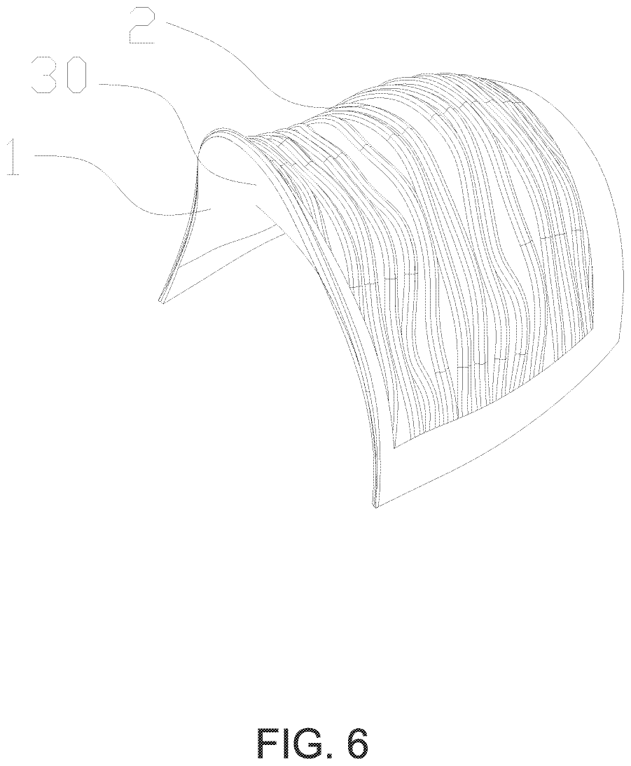

As shown in FIGS. 1-6, the overall shape of the transverse section of the said elastic heel is a C-shaped curved plane. The said elastic heel consists of an inner surface 1 and an outer surface 2, including an entrance portion 3, a transition portion 4, a container portion 5 and a bottom portion 6 from top to bottom. The said entrance portion 3 has a curved rim inclining from the inner surface 1 to the outer surface 2.

The said transition portion 4, connected with the entrance portion 3, is an are inclining from the outer surface 2 to the inner surface 1 and the slope of its inner surface 1 is larger than that of its outer surface 2, forming a pressed platform 30 extending inwards at the inner surface of the entrance portion 3 to facilitate feet to step on the platform 30 when the shoes are being put on so as to squeeze the heel outwards and downwards. The container portion 5 is an arc bending towards the inner surface 1 of the heel. The outer surface 2 of the elastic heel is covered with curved lines set transversely along the heel. And this heel is made seamlessly of the elastic material. The material of the said clastic heel is one selected from foam rubber, elastic PU, foamed latex, foam sponge, PVC foam and EVA foam. The said elastic heel is a one-piece molding from a mold.

As a preferred option of this embodiment, thickness of the transition portion 4 of the elastic heel decreases gradually from the middle to two sides. This structure, on one hand, makes the inner surface 1 of the heel fits the foot heel and ankle better to be more comfortable to wear; on the other hand, gradual thickness decrease towards two sides reduces the total weight of the heel, making it lighter. Moreover, gradual thickness decrease towards two sides thus makes connection with the upper more smooth-going, and lessens the unevenness caused by splicing.

As a preferred option of this embodiment, the two sides of the said elastic heel also include connecting portions 7 that are strips extending from the entrance portion 3 of the heel to the bottom portion 6. This connecting portion 7 is also an integrated part of the one-piece molded heel. Its thickness is similar to or the same as thickness of the upper to be spliced, so it will be closer to flatness, good for the subsequent splicing process.

As a preferred option of this embodiment, the material of the elastic heel is one from foam rubber, elastic PU, foamed latex, foam sponge, PVC foam and EVA foam. These materials are soft, good in rebound resilience, compressible under load, and resilient after the load is removed. And in combination with the structure of the heel of this embodiment, they contribute to quick slip-on and prevent heel slip.

As a preferred option of this embodiment, given subsequent processing to connect the heel with the sole, the bottom portion 6 of the said elastic heel is 1-1.5 mm thick while the heel is 5-10 mm high, so the bottom portion 6 is thin and relatively flat. Therefore, the outer surface 2 of the bottom portion 6 could be free of curved lines, facilitating the subsequent adhesion or stitching with the sole.

As a preferred option of this embodiment, the upper edge of the entrance portion 3 is descending in height from the middle to two sides along the transverse direction of the heel, forming an arch whose middle is higher than its two sides. Such structure contributes to better transition during connection with the upper. The generally higher middle area is more favorable for stability when the shoes are put on.

The elastic heel of this embodiment is made by the following process:
(1) Material configuration: selecting a material from foam rubber, elastic PU, foamed latex, foam sponge, PVC foam and EVA foam required for configuration upon the need;
(2) Mold preparation: preparing the heel mold consisting of upper and lower platens, among which the inside surface of the lower platen is a concave having the same shape as the heel outer surface while the inside surface of the upper platen is a convex having the same shape as the heel inner surface;
(3) Placing the solid foaming material of the Step (1) in the mold and closing the mold halves to proceed foam forming;
(4) Opening the mold for demolding.

As a preferred option of this embodiment, the obtained heel is trimmed to make the finished goods.

### Embodiment 2

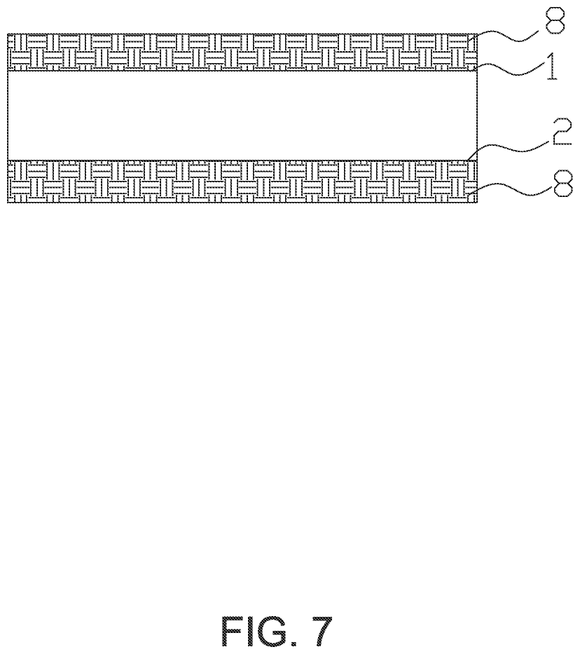

This embodiment is a variant of the embodiment 1 to facilitate connecting with the upper and processing. As shown in FIG. 7, the elastic fabric 8 fits onto the inner surface 1 and outer surface 2 of the said elastic heel. During heel molding, the elastic fabric 8 is assembled with the heel by hot pressing directly. The fitting is firm and no subsequent lamination processing is required. The pattern or color of the laminated elastic fabric 8 is optional according to the design demand.

As a preferred option of this embodiment, the inner surface and outer surface 2 of the elastic heel fits well with the knitted fabric or tatted four-sided elastic fabric. The fabric of the inside surface is delicate, which can be more skin friendly to feet, further improving comfort.

In the manufacturing process of the elastic heel of this embodiment, the foresaid Step (2) is preparing the heel mold consisting of upper and lower platens, among which the inside surface of the lower platen is a concave having the same shape as the heel outer surface while the inside surface of the upper platen is a convex having the same shape as the heel inner surface, and laying the elastic fabric on the inside surface of the lower platen.

The foaming material of the above embodiment is one from solid foam rubber, elastic PU, foamed latex, foam sponge, PVC foam and EVA foam.

### Embodiment 3

This embodiment delivers an example of the foaming material of a type of elastic heel. Specifically, it is preparing the shoe heel mold consisting of upper and lower platens, among which the inside surface of the lower platen is a concave having the same shape as the heel outer surface while the inside surface of the upper platen is a convex having the same shape as the heel inner surface; the primary component is polyol mixture including the secondary component isocyanate pre-polymer in proportion of 100/40-60.

As a preferred option of this embodiment, the said polyol mixture includes polyol, hardener 18-20 g/kg, catalyst 20-25 g/kg, foaming agent 9-13 g/kg, anti-yellowing agent 20-25 g/kg, and foam stabilizer 10-20 g/kg.

As a preferred option of this embodiment, the density of the said elastic PU material is 0.30-0.35 g/cm3.

As a preferred option of this embodiment, the hardness of the said elastic PU material is 30-40 Asker C.

As a preferred option of this embodiment, the said primary component also includes color paste.

The foaming material of this embodiment is liquid, so the difference between its manufacturing process and the abovementioned embodiment is as follows: at the Step (2), the liquid ether-based two-component PU foam is filled in the lower platen first, and then the elastic fabric is placed in the upper platen followed by foaming molding after mold halves are closed.

As a preferred option of this embodiment, the abovementioned ether-based two-component PU foam system consists of the primary and secondary components; the said primary component is polyol mixture including the said secondary component, isocyanate pre-polymer, in proportion of 100/40-50 of the said primary component to secondary component.

As a preferred option of this embodiment, at the Step (1), the said isocyanate pre-polymer is conditioned in an oven at 60-70° C. for 6˜10 hours until getting molten and then moved to another oven at 35-45° C. for thermal preservation; meanwhile the polyol is conditioned in an oven at 44˜55° C. for 6˜10 hours and then moved to another oven at 35-45° C. for thermal preservation; and then the polyol is mixed with hardener 18-20 g/kg, catalyst 20-25 g/kg, foaming agent 9-13 g/kg, anti-yellowing agent 20-25 g/kg, and foam stabilizer 10-20 g/kg under 35˜45° C. for 5˜15 minutes to get the primary component.

As a preferred option of this embodiment, the primary component is mixed with the secondary component in proportion of 100-40/60; its emulsification time is 6-10 s, cross-linking time 25-35 s, hands-off time 50-70 s, foaming time 80-90s, and free foaming density 0.125-0.165 g/cm3.

As a preferred option of this embodiment, at the said Step (3), the mold pressing temperature is 40-55° C., and demolding time is 3-6 minutes.

As a preferred option of this embodiment, after demolding, the heel is conditioned in the oven at 60-70° C. for 8-12h to obtain the elastic heel to be cured.

All indicators of the heel obtained from this embodiment are shown in Table 1:

TABLE 1
Test Result of the Heel of the Embodiment 1

| Standard property | Unit | Test method | Test result |
|---|---|---|---|
| Finished goods density | g/cm³ | DIN53505 | 0.33-0.38 |
| Hardness | Asker C | DIN53497 | 35~40 |
| Tensile strength | MPA | DIN53504 | >0.5 |
| Elongation | % | DIN53328 | >150 |
| Tear strength | N/mm | DIN53329 | >0.4 |
| Mid-cut tear strength | N/cm | DIN53507-B | >0.3 |
| Compression set | % | ASTM D-395 | <25 |

| | |
|---|---|
| Hydrolysis | >70% |
| resistance, 95% RH, | |
| 70° C., 3 weeks | |

The property of the elastic heel of this embodiment is good. The compression set is good, and hardness appropriate. Its application to the footwear can produce a type of quick slip-on shoes.

### Embodiment 4

This embodiment provides a type of elastic heel comprising the foam rubber. Specifically, the said elastic heel is a structure made of the mixture of foam rubber sheets. The said foam rubber sheet is mixed in proportion of 80-100 pcs of natural rubber, 20-40 pcs of butadiene rubber, 60-80 pcs of talc, 13-15 pcs of zinc oxide, 10-20 pcs of elastomer, 2-3 pcs of anti-yellowing agent, 5-8 pcs of anti-aging agent, 1-2 pcs of accelerator D, 2-3 pcs of sulfur, and 3-5 pcs of foaming agent (in weight). The test result of this elastic heel is shown in Table 2.

TABLE 2
Test Result of the Heel of the Embodiment 2

| Standard property | Unit | Test method | Test result |
|---|---|---|---|
| Finished goods density | g/cm³ | DIN53505 | 0.42-0.45 |
| Hardness | Asker C | DIN53497 | 45-55 |
| Tensile strength | MPA | DIN53504 | >0.7 |
| Elongation | % | DIN53328 | >140 |
| Tear strength | N/mm | DIN53329 | >0.6 |
| Mid-cut tear strength | N/cm | DIN53507-B | >0.35 |
| Compression set | % | ASTM D-395 | <20 |

| | |
|---|---|
| Hydrolysis | >75% |
| resistance, 95% RH, | |
| 70° C., 3 weeks | |

### Embodiment 4

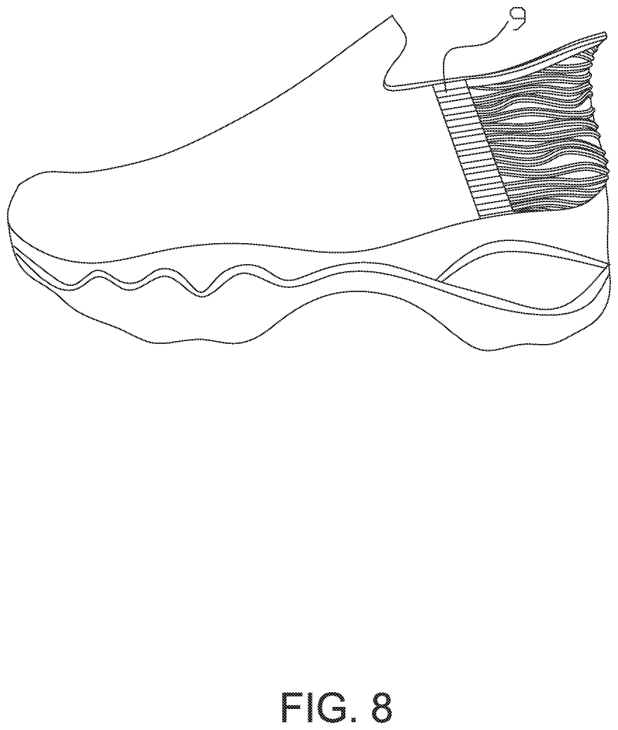

This embodiment raises a type of quick slip-on shoes. As shown in FIG. 8, a quick slip-on shoe consists of the upper, heel and sole. The said elastic heel is the foresaid heel.

As a preferred option of this embodiment, the said quick slip-on shoes have the hell and the upper stitched together, plus webbing stitched on the outside of the suture and thus covering the suture.

However, the connection of the heel and the upper is not limited to this means. There are other means available. For example, the heel part of the upper adopts a sandwich structure to have the elastic heel included, stitched and fixed. Persons skilled in the art may select a proper method to connect the elastic heel with the upper to make a type of quick slip-on shoes based on the need of the whole shoe design.

### Embodiment 5

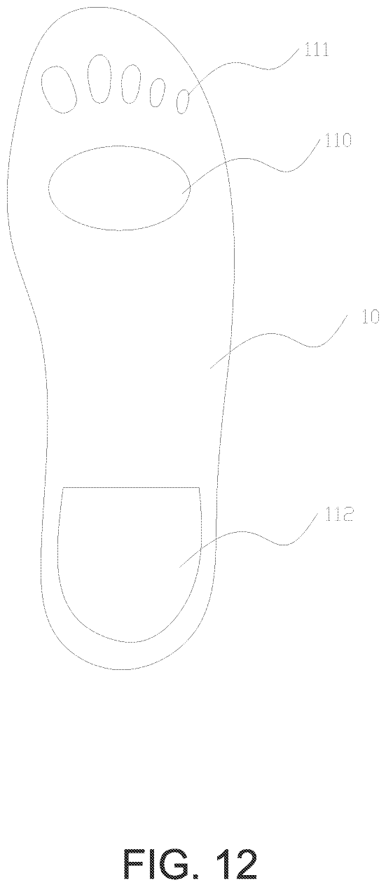

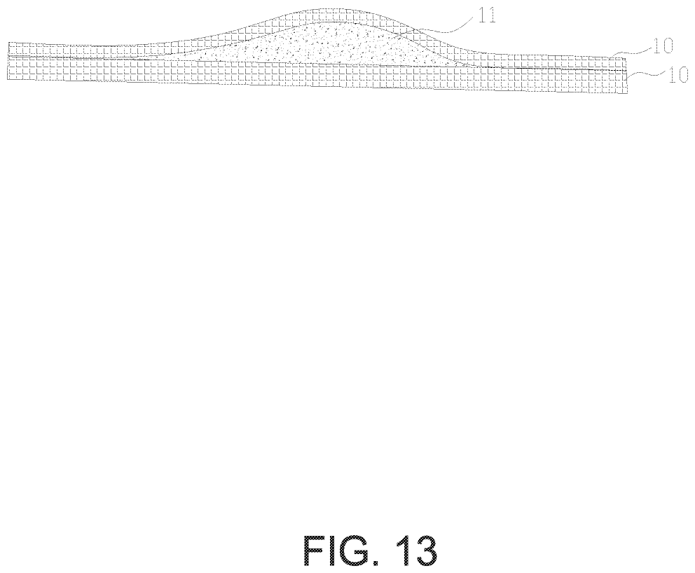

This embodiment raises a type of pressure relief insole. As shown in FIGS. 12-13, it includes an insole body 10 and a filling area 11. The said insole body 10 consists of warp knitted air mesh textile laminated from top to bottom. The insole body 10 is 6-7 mm thick. The said filling area 11 includes a sole filling area 110, a toe filling area 111, and a heel filling area 112. The material of the said sole filling area 110 is fine wool; the material of the said toe filling area 111 is coarse wool; the material of the said heel filling area 112 is ultra-light clay particles of 0.8-1.2 mm diameters. The spinnability of the coarse wool is poor, so it is underused in the field of footwear. The downgrading that it is used as a filler not only promotes its value, but also provides good support and resilience, so it plays a role in support and pressure relief. The fine wool can also provide the same good resilience, and it is softer than the coarse wool, so the filling area 11 made of the fine wool will be softer than that made of the coarse wool. Likewise, the ultra-light clay particle also is very resilient and light weighted. Its application in the heel filling area 11 can reduce the weight of the heel and relieve pressure.

As a preferred option of this embodiment, the said filling area 11 is 10-12 mm thick.

As a preferred option of this embodiment, the average fineness of the said fine wool is 16-18 μm, and that of the coarse wool is 62-64 μm.

As a preferred option of this utility model, all textiles of the insole body 10 are bonded or stitched.

The test pressure of the insole obtained from this embodiment is shown in Table 2:

TABLE 2
Insole Pressure Test Result

| | | | Foot bottom pressure- | |
|---|---|---|---|---|
| | Max pressure value | | time integral | |
| | Average test | Average test | Average test | Average test |
| Measurement | result of | result of | result of | result of |
| area | bare foot | insole | bare foot | insole |
| Foot heel area | 60.41 | 5.23 | 10.88 | 0.77 |
| Sole area | 24.35 | 5.03 | 6.55 | 1.09 |
| Toe area | 22.88 | 1.85 | 7.23 | 0.23 |
| Whole foot | 107.64 | 12.11 | 24.66 | 2.09 |

The insole of this embodiment is characterized by pressure relief and wear comfort.

### Embodiment 6

This embodiment raises a type of insole that has the function of massage. This insole includes a sole area, a foot arch area, a heel area and a toe area. The sole from top to bottom consists of an upper layer and a lower layer. The upper layer has multiple massage bumps. The said massage bump is a semi-sphere comprising a skin and a core. The skin is not as hard as the core.

The core hardness is 30-35 Asker C while the skin hardness is 45-50 Asker C. The height of the said core is 2-2.5, and the thickness of the said skin is 2-2.5 mm. The positions of massage bumps match acupoints at the bottom of feet. They massage the feet when one is walking. And the skin hardness is relatively small, so when the foot is mainly supported by the core, the skin provides a certain buffer and softness to improve the wear comfort.

### Embodiment 7

This embodiment is a variant of the embodiment 7. Its massage bumps and the insole body are made of materials specifically as follow: the insole body 10 consists of warp knitted air mesh textile laminated from top to bottom; thickness of the insole body 10 is 6-7 mm. The core of massage bumps also consists of warp knitted air mesh textile laminated from top to bottom; its height is 0.2-0.25 mm. The skin of massage bumps is made of bonded elastic PU material. This elastic PU material can be the elastic PU material of the foresaid embodiment with hardness of 35˜40 Asker C. In this case, the insole made has the same massage function.

To equip the insole with other functions, far-infrared ceramic powder, graphene or antibacterial materials can be added to the insole body material or the elastic PU material upon corresponding functions.

### Embodiment 8

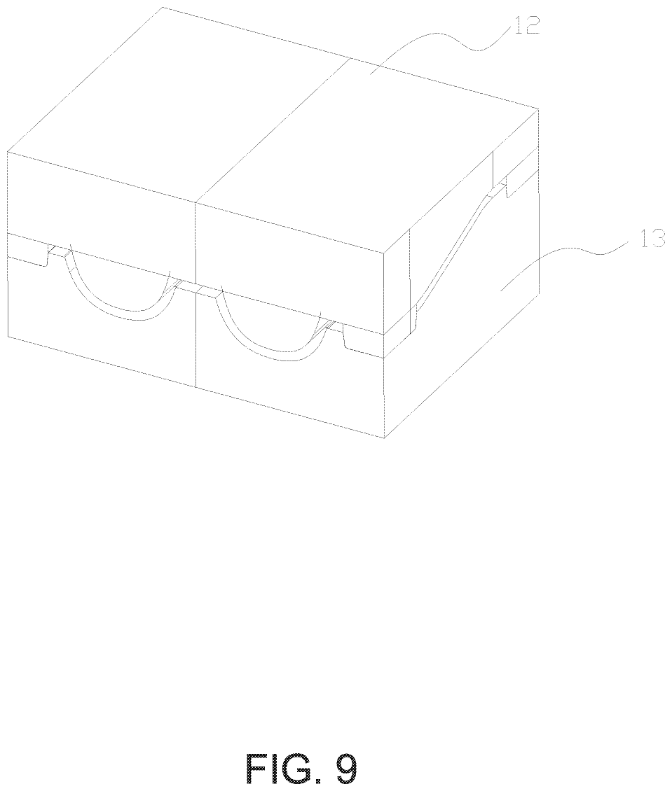

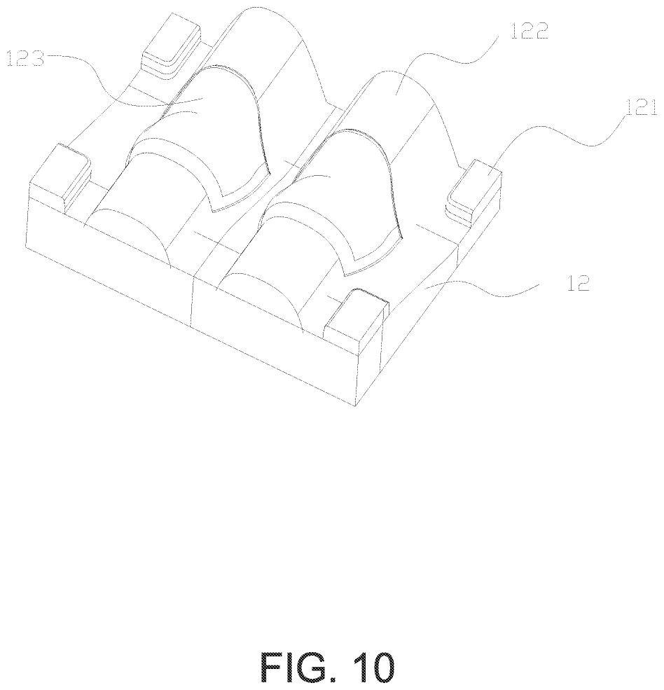

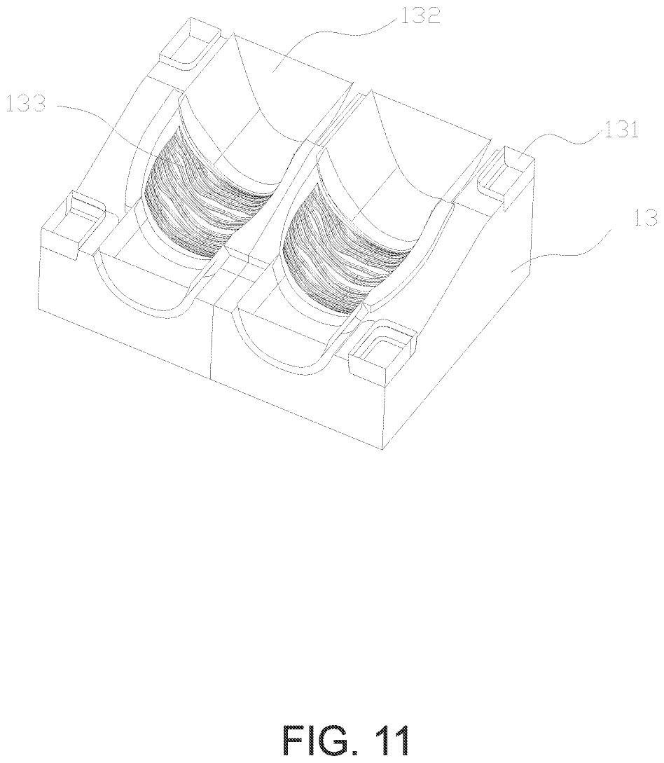

This embodiment raises a type of heel mold, as shown in FIGS. 9-11, including upper and lower platens. The heel mold consists of an upper platen 12 and a lower platen 13. The lower platen 13 consists of the cavity 133, whose concave surface has the same shape as the outer surface of the heel. In addition, the lower platen 13HIA includes the groove 132 around the cavity 133, and the slots for locking the upper platen 12 and lower platen 13. The upper platen consists of the core 123, whose convex surface has the same shape as the inner surface of the heel. In addition, the upper platen 12 also includes the rib 122 around the core 123 to be fit into the groove 132 and used to seal the surrounding of the cavity and core when the upper platen 12 and the lower platen 13 are closed to prevent raw material overflow. The upper platen also includes the clips 121 at four corners to be fit into the slots 131, used to fix and prevent misalignment or dislocation after the upper platen 12 and the lower platen 13 are closed. The said upper platen has several venting holes. For example, there are 4 venting holes. The venting hole setting is good for the gas between the upper and lower platens to be exhausted during the process of foaming to prevent local defects during foaming.

It should be noted that the above describes the present invention by reference to the embodiment form, but without deviating from the range of the present invention, the present invention can be modified in various manners and its components can be replaced with the equivalent ones. In particular, all characteristics of the embodiment forms disclosed in the present invention can be combined with each other in any ways so as to be used as long as there is no structural conflict. In this description, the combinations are not described exhaustively only for the sake of space saving and resource conservation. Therefore, the present invention is not limited to the certain embodiment forms published in this document, but includes all technical solutions within the range of the claims of the present invention.

What is claimed is:

1. The manufacturing process of a type of elastic heel is characterized by: including the following steps:
(1) Material configuration: selecting a material from foam rubber, elastic PU, foamed latex, foam sponge, PVC foam and EVA foam required for configuration upon the need;
(2) Mold preparation: preparing the heel mold consisting of upper and lower platens, among which the inside surface of the lower platen is a concave having the same shape as the heel outer surface while the inside surface of the upper platen is a convex having the same shape as the heel inner surface, and there are venting holes on the upper platen for gas exhaust, and on the inside surface of the lower platen lays the elastic fabric;
(3) Placing the solid foaming material of the Step (1) in the mold and closing the mold halves to proceed foam forming;
(4) Opening the mold for demolding.

2. The manufacturing process of a type of elastic heel described in accordance with the claim 1 is characterized by the following: the lower platen consists of a cavity, a groove around the cavity, and slots for locking the mold halves; the upper platen consists of a core, a rib around the core, and clips at four corners to be fit into the slots of the lower platen. The said upper platen is designed with several venting holes.

3. The manufacturing process of a type of elastic heel described in accordance with the claim 1 is characterized by the following: the heel from top to bottom consists of an entrance portion, a transition portion, a container portion and a bottom portion. The said entrance portion has a curved rim inclining from the inner surface to the outer surface. The said transition portion, connected with the entrance portion, is an arc inclining from the outer surface to the inner surface, and the slope of its inner surface is larger than that of its outer surface, thus forming a pressed platform extending inwards at the inner surface of the said entrance portion. The said container portion is an arc bending towards the inner surface of the heel. The outer surface of the said elastic heel is covered with curved lines set transversely along the heel. The two sides of the said elastic heel also include connecting portions that are strips extending from the entrance portion of the heel to the bottom of the shoe.

4. The manufacturing process of a type of elastic heel described in accordance with the claim 3 is characterized by the following: at the Step (2), the liquid ether-based two-component PU foam is filled in the lower platen first, and then the elastic fabric is placed in the upper platen followed by foaming molding after mold halves are closed, in case that the raw material at the Step (1) is a liquid ether-based two-component PU foam.

5. The manufacturing process of a type of elastic heel described in accordance with the claim 4 is characterized by the following: the abovementioned ether-based two-component PU foam system consists of the primary and secondary components; the said primary component is polyol mixture including the said secondary component, isocyanate pre-polymer, in proportion of 100/40-50 of the said primary component to secondary component.

6. The manufacturing process of a type of elastic heel described in accordance with the claim 5 is characterized by the following: at the Step (1), the said isocyanate pre-polymer is conditioned in an oven at 60˜70° C. for 6˜10 hours until getting molten and then moved to another oven at 35-45° C. for thermal preservation; meanwhile the polyol is conditioned in an oven at 44˜55° C. for 6˜10 hours and then moved to another oven at 35˜45° C. for thermal preservation; and then the polyol is mixed with hardener 18-20 g/kg, catalyst 20-25 g/kg, foaming agent 9-13 g/kg, anti-yellowing agent 20-25 g/kg, and foam stabilizer 10-20 g/kg under 35˜45° C. for 5˜15 minutes to get the primary component.
